(19) United States
(12) Patent Application Publication
(10) Pub. No.: US 2026/0186865 A1
(43) Pub. Date: Jul. 2, 2026

(54) NATURAL LANGUAGE INTERFACE FOR INTERACTING WITH DISPARATE APPLICATION PROGRAMMING INTERFACE SYSTEMS AND APPLICATIONS

(71) Applicant: NVIDIA Corporation, Santa Clara, CA (US)

(72) Inventors: Roopa Prabhu, San Jose, CA (US); Rohit Ramesh Vaswani, San Jose, CA (US); Nalin Dadhich, San Jose, CA (US); Bruno Alvisio, San Bruno, CA (US); Joshua Roorda, Santa Clara, CA (US)

(21) Appl. No.: 19/005,598

(22) Filed: Dec. 30, 2024

(51) Int. Cl. G06F 9/54; G06F 40/20

(52) U.S. Cl. CPC G06F 9/54; G06F 40/20

(57) ABSTRACT

In various examples, a system(s) may use one or more language models to convert natural language queries into application programming interface (API) calls for interacting with a variety of cloud-based services or applications. For instance, based at least on receiving input data representing a natural language query, the system(s) may execute multiple language model calls to, among other things, determine an optimal service(s) to invoke for responding to the query and generate one or more API calls to send to an API(s) of the service(s)—which may include identifying an optimal API endpoint(s) to use and correctly formatting the API call(s) to include necessary parameters and/or other information. Additionally, in some examples, the system(s) may use the language model(s) to convert a response(s) to the API call(s) back into a natural language reply to the query (e.g., convert from JSON or XML into natural language).

### BACKGROUND

In general, cloud-delivered services and applications are typically interacted with using application programming interfaces (APIs), which may provide a standardized way for clients, applications, and/or other systems to communicate with the cloud resources that they need. Because APIs generally follow common web standards (e.g., REST, GraphQL, etc.) and return data in predictable formats (e.g., JSON, XML, etc.), cloud-delivered services may be accessible from a wide variety of applications and/or platforms. For instance, APIs may allow developers to perform various tasks such as data storage and/or retrieval tasks, provisioning virtual machines, database management tasks, and/or resource scaling—all without potentially needing to manage the underlying infrastructure of a cloud-delivered service directly. Additionally, by sending requests to these APIs, applications can leverage cloud-delivered resources in real time, thereby allowing the applications to benefit from the flexibility, scalability, and cost-efficiency that cloud computing offers.

However, interacting with a variety of different cloud-based services can oftentimes be challenging. For example, because different cloud providers may offer different sets of APIs with unique authentication mechanisms, data formats, and protocols, this diversity can make it difficult for developers to integrate multiple cloud-based services into a single, cohesive system, especially when each API may have its own nuances and limitations (e.g., authentication mechanisms, rate limits, data formats, versioning, error handling, latency, etc.). While some proposals have attempted to address the challenges of interacting with diverse cloud APIs, existing solutions often fall short in key areas. For example, some existing solutions may rely on a single Large Language Model (LLM) call to manage the complexity of API interactions. However, relying on a single LLM call may lead to performance issues including, but not limited to, low accuracy, hallucinations, high latency, and non-reproducibility. Moreover, customization is often limited in these existing systems, as they tend to be one-size-fits-all solutions that may not adapt well to specific needs or complex workflows. Thus, when dealing with real-world APIs—which can be complex and come with strict security, rate-limiting, and/or other requirements—most existing solutions may not be robust or flexible enough to handle diverse scenarios effectively, making it difficult to create reliable, scalable integrations between different cloud-based services.

### SUMMARY

Embodiments of the present disclosure relate to a natural language interface for interacting with disparate application programming interface systems and applications. Systems and methods are disclosed that may use one or more language models to convert natural language queries into application programming interface (API) calls for interacting with a variety of cloud-based services or applications.

For instance, based at least on receiving input data representing a natural language query, the systems of the present disclosure may execute multiple language model calls to, among other things, determine one or more optimal services (e.g., cloud-based services or applications) to invoke for responding to the query and generate one or more API calls to send to one or more APIs (e.g., cloud APIs) of the service(s)—which may include identifying one or more optimal API endpoints to use and/or correctly formatting the API call(s) to include necessary parameters and/or other information. In some examples, to determine the optimal services and/or generate the API call(s), the system(s) may apply, to the language model(s), a plurality of API specifications associated with the API(s) for the service(s). For instance, the system(s) may apply the API specifications during training and/or concurrently when making the language model calls to determine the optimal services and/or generate the API call(s). Additionally, in some examples, the system(s) may use the language model(s) to convert one or more responses to the API call(s) back into a natural language reply to the query (e.g., convert from JSON or XML into natural language).

In contrast to conventional systems, the systems of the present disclosure, in some embodiments, are able to interact seamlessly with a variety of different services and applications by accommodating the unique differences, nuances, and specifications of their respective APIs. For instance, by using language models to process API specifications contemporaneously with natural language queries, the systems of the present disclosure are able to generate API calls for a variety of different APIs, thereby allowing developers and/or other clients to integrate multiple cloud-based services into a single, cohesive system regardless of API diversity. Additionally, by executing multiple language model calls per query to divide the solution into multiple smaller tasks (e.g., server classification, API classification, parameter filling, API call execution, and response generation), the systems of the present disclosure are able to ensure better control and easier performance of specialized tasks. Further, by customizing different parts of the pipeline and adding customizable rules for each stage through configuration files, the systems of the present disclosure are able to ensure reliable performance across a wide variety of systems.

### BRIEF DESCRIPTION OF THE DRAWINGS

The present systems and methods for a natural language interface for interacting with disparate application programming interface (API) systems and applications are described in detail below with reference to the attached drawing figures, wherein:

FIG. 1 is a data flow diagram illustrating an example of a process that may be performed by an application to provide a natural language interface for interacting with disparate APIs of different services, in accordance with some embodiments of the present disclosure;

FIG. 2 is a block diagram illustrating example detail associated with an agent, in accordance with some embodiments of the present disclosure;

FIG. 3 is a data flow diagram illustrating an example of a process performed at least partially by a planner node to select one or more optimal service for responding to a query, in accordance with some embodiments of the present disclosure;

FIG. 4 is a data flow diagram illustrating an example of a process performed at least partially by an API tool to convert queries into API calls, in accordance with some embodiments of the present disclosure;

FIG. 5 is a data flow diagram illustrating an example of a process performed at least partially by a response node to convert a response to an API call into output data representing at least a natural language message, in accordance with some embodiments of the present disclosure;

FIG. 6 is a block diagram illustrating an example of a system that may perform one or more of the processes described herein, in accordance with some embodiments of the present disclosure;

FIG. 7 is a flow diagram illustrating an example of a method that may be performed to provide a natural language interface for interacting with APIs of a service, in accordance with some embodiments of the present disclosure;

FIG. 8 is a flow diagram illustrating an example of a method for converting natural language queries into API calls and translating responses to the API calls back into natural language messages, in accordance with some embodiments of the present disclosure;

FIG. 9A is a block diagram of an example generative language model system suitable for use in implementing at least some embodiments of the present disclosure;

FIG. 9B is a block diagram of an example generative language model that includes a transformer encoder-decoder suitable for use in implementing at least some embodiments of the present disclosure;

FIG. 9C is a block diagram of an example generative language model that includes a decoder-only transformer architecture suitable for use in implementing at least some embodiments of the present disclosure;

FIG. 10 is a block diagram of an example computing device suitable for use in implementing at least some embodiments of the present disclosure; and

FIG. 11 is a block diagram of an example data center suitable for use in implementing at least some embodiments of the present disclosure.

### DETAILED DESCRIPTION

Systems and methods are disclosed related to a natural language interface for interacting with disparate application programming interface (API) systems and applications. For instance, a system(s) may receive, from a client device, input data representing a query (e.g., a natural language query). In some examples, the client device may be executing an instance of a user interface, and the input data may be received via the user interface executing on the client device. For instance, a user of the client device may use the user interface to enter the query (e.g., by speaking or uttering the query, by typing the query, writing the query, etc.). In some examples, the input data may include text data representing the query. Additionally, in some instances, the input data may include multimodal data (e.g., a combination of two or more of text data, audio data, image data, video data, etc.). As described herein, in various examples, the query may comprise a request for information (e.g., “what is the weather like today,” “how many people are in the building,” etc.), a request to control a machine or device or perform an action (e.g., “turn up the thermostat,” “lock the doors,” etc.), or any other request(s) or query(ies).

In some instances, the system(s) may include a plurality of AI agents (e.g., LLM-powered agents or any other kind of agents), which may include a plurality of nodes, and the nodes may be configured to perform a variety of different functions on behalf of the system(s) and/or the agents to generate a response to the query. For instance, the system(s) may include a planner node, a tool node, a response generation node, and/or any other nodes. The nodes may include or use one or more language model(s) to understand context, generate human-like responses, process natural language, and/or integrate with other tools for comprehensive functionality.

For instance, the planner node may use the language model(s) to determine optimal services or applications (e.g., cloud-based services) to invoke for generating responses to queries, and the planner node may map the queries (or sub-queries within a query) to the optimal services. In some examples, the planner node may use the language model(s) to process the input data representing the query and information associated with the service(s). Such information may include, but is not limited to, information describing the capabilities, functions, tools, and/or uses of the services. In this way, the planner node may use the language model(s) to determine the optimal services that should be invoked to respond to the queries. As an example, if a query asks about the weather at a certain location, the planner node may use the language model(s) to determine to invoke/select a weather service that may have knowledge of the weather at that location.

In some examples, a query may include multiple queries, and the planner node may use the language model(s) to decompose the query into individual, simpler queries (e.g., sub-queries), as well as to identify the optimal services to route each different query to. For instance, if the query includes a first query asking about the weather at the certain location and a second query asking about what time the football game is, the planner node may use the language model to decompose the query into the first query and the second query, as well as to determine that the optimal service for the first query is the weather service and that the optimal service for the second query is a sports service and/or a television service.

In some examples, the services may include cloud-delivered services, on-premise services, or any other service delivered or hosted on any type of infrastructure. In some examples, the services may include, but are not limited to, weather services (e.g., weather forecast services, environment/climate monitoring services, etc.), analytics services (e.g., website or user analytics services, business intelligence and data visualization services, performance and user behavior tracking services, etc.), payment processing services (e.g., online payment gateways, E-commerce checkout solutions, digital wallet and mobile payment systems, etc.), cloud storage services (e.g., file storage and sharing, backup and disaster recovery, data archiving services, etc.), content delivery network services, authentication and identity services (e.g., SSO solutions, multi-factor authentication services, etc.), email and messaging services, cloud computing services (e.g., software as a service (SaaS), platform as a service (PaaS), etc.), machine learning and AI services (e.g., language processing services, image and video recognition services, etc.), geolocation and mapping services, video and streaming services, social media services, customer support and helpdesk services, E-commerce services, database services, cybersecurity services, and telecommunication services. In various examples, the services may include Representational State Transfer (REST)-based APIs that follow the design principles of the REST architectural style, allowing the services to exchange data with each other and/or other systems using standard HTTP methods—such as GET, POST, PUT, and/or DELETE—through web URLs and/or other modalities. In at least one example, the services may include an autonomous machine deployment or management service, and API calls may be submitted to the service to cause one or more machines (e.g., a fleet of autonomous machines) to perform one or more operations. For instance, a query may be submitted requesting a ride, requesting aid, requesting delivery of an item(s), etc., and an API call may be generated from the query and submitted to such an autonomous machine deployment service, and the service may dispatch a machine (e.g., an autonomous machine or vehicle) to a specific location (e.g., a location indicated in the query or a current location of a user).

As described herein, in some instances, the system(s) may also include the tool node, and the tool node may manage a plurality of AI-based agent tools. In some examples, each tool of the plurality of tools may correspond to or be associated with a specific service of the services, thereby creating structured interaction pathways for executing API calls. As such, although it is described above that the planner node may map the queries to the optimal services, the planner node may, in other words, map the queries to one or more of the tools corresponding to one or more of the services. In some examples, the tool node may make multiple calls to the language model(s) to, among other things, perform query decomposition (if necessary), determine appropriate API endpoints to use for the API calls, and/or generate the API calls themselves (e.g., fill in parameters and/or other information).

For instance, the tool node and/or the tools may use the language model(s) to perform query decomposition. As an example, if a query were to ask “what is the weather in California and what is the weather in Idaho,” the tool node and/or the tools may use the language model(s) to decompose the query into two separate queries: a first query for “what is the weather in California” and a second query for “what is the weather in Idaho.” In this way, by decomposing the query, the tool node and/or the tools may be able to generate an API call for each of these queries and submit these API calls separately to the backend service. Thus, while the planner node may decompose queries in order to determine the optimal services to use to respond to the queries, the tool node and/or the tools may decompose queries in order to determine what API calls should be made to the optimal services selected by the planner node.

In some examples, the tool node and/or the tools may use the language model(s) (e.g., call the language model(s)) to classify each query into APIs to call (or a chain of APIs for complex queries). For instance, based on using the language model(s) to process the query and API specifications associated with the services, the tool node and/or the tools may determine which API endpoint(s) to use to make the API calls to the services. In some examples, the language model(s) may select the API endpoint(s) based on the specific functionalities they provide and whether those functionalities matches the operation that needs to be performed to respond to the query, such as retrieving data, updating resources, creating new entries, etc. This selection process may involve the language model(s) consulting the API specifications (e.g., via augmentation) to understand the available endpoints, their HTTP methods (e.g., GET, POST, PUT, DELETE, etc.), required parameters, and response formats. For instance, the API specifications associated with the services may indicate one or more endpoints (e.g., URL addresses, etc.) corresponding to the APIs for the services, functionalities of the endpoint(s), parameters to be included in the payload of API calls, formats of the API requests or responses, or any other information associated with the APIs of the services.

In some examples, the tool node and/or the tools may also call the language model(s) to generate the API calls. For instance, the tool node and/or the tools may apply, to the language model(s), at least a portion of the input data and the API specifications associated with the services. The language model(s) may process these inputs and generate text data representing the API calls. That is, the language model(s) may analyze the query and API specifications to generate the payload for each API call by, at least, specifying an endpoint, using an HTTP method (e.g., GET, POST, PUT, DELETE), and filling in the parameters and/or other data payloads for the API call. The tool node and/or the tools may then execute the API calls by sending them to the API endpoints for the services.

In some examples, based at least on executing the API calls, the tool node and/or the tools may receive responses to the API calls from the backend services and/or the APIs of the backend services. The responses to the API calls may, in some instances, be in a format that is not a natural language format. For instance, the responses may include text data representing JSON format responses, XML format responses, or any other structured format response. The responses to the API calls may be forwarded to the response generation node of the system(s). The response generation node may use the language model(s) to convert the API responses from the structured format into a natural language format. For instance, the response generation node may use the language model(s) to process, as inputs, the queries, the API responses, and the API specifications. Based on the language model(s) processing these inputs, the language models may generate output data representing at least natural language responses to the queries. For instance, the API specifications may outline how the data returned by the API will be structured and formatted (e.g., whether the data is returned as a JSON object, an array, or an XML document, as well as the hierarchy of keys and values, the types of data (e.g., strings, numbers, booleans) associated with each key, etc.). In some examples, the output data may represent a multimodal response to the query. For instance, the output data may include a combination of two or more of text data, audio data, image data, video data, and/or other data. As an example, the output data may include an image or a video and text data representing a natural language description of the content depicted in the image or video.

The system(s) may then send the output data to the client device. In some examples, the output data may be presented by the client device via an instance of a user interface executed on the client device. In other words, by sending the output data to the client device, the system(s) may cause the client device and/or the user interface to cause presentation of the response to the query. In some examples, causing presentation of the response may include, but is not limited to, outputting audio data of the response using one or more speakers of the client device, outputting visual data of the response (e.g., image data, text data, analytics data, etc.) using a display of the client device, or outputting any other data using any other components or modalities of the client device.

In some examples, the AI-based agent tools may include a visualization tool. In some instances, the visualization tool (or service) may be configured to generate one or more charts or plots based on an input query. The visualization tool may, in some instances, operate in two phases. The first phase (e.g., data transformation) may effectively convert API JSON data into (X, Y) values. Taking the user's query and API JSON as input, this step may use an LLM to generate the required (X, Y) data points for plotting. The second phase (e.g., code generation) may effectively transform the (X, Y) values into chart code. For instance, the visualization tool may use another LLM call to determine the appropriate chart type and produce the corresponding code for visualization. Once the chart code is generated, the response node may combine it with a natural language explanation. As an example, when a user inputs a query, such as “plot me the number of boxes we were able to pack at conveyor belt A over the last week,” the planner node may determine to invoke the visualization tool, and the visualization tool may ultimately produce an output, such as “here is a plot of box count I found over the last week: [chart]” (where the plot is inserted (e.g., as a picture, etc.) in place of “[chart]”). The planner node may then send this combined output to the UI, which displays the natural language response alongside the rendered chart in a chat window, providing a seamless and informative user experience.

Additionally, in some examples, the AI-based agent tools may include a prediction tool. In some instances, the prediction tool (or service) may be configured to make predictions or otherwise forecast future trends based on historical data. The prediction tool may, in some instances, performs two primary functions: data transformation and prediction modeling. During data transformation, the prediction tool may convert API JSON data into (X, Y) values. For instance, using the user's query and API JSON as input, this step may employ an LLM to generate the relevant (X, Y) data points for further analysis. The second function of running prediction models may include the prediction tool using the (X, Y) values to forecast future trends. By applying time-series prediction models (e.g., algorithmic models, machine learning models, etc.), this step may calculate the value of Y′ for a given X=X′ value, aligning with the user's query for future data predictions. As an example, when a user inputs a query, such as “based on the number of orders we had received in last 3 months, how many orders do we expect in coming weeks,” the planner node may determine to invoke the prediction tool, and the prediction tool may ultimately produce an output, such as “based on previous patterns we expect about 40 orders this week.”

In some examples, the system(s) may determine to invoke multiple different tools and combine multiple different outputs from the different tools. For example, consider the same example query from above, “based on the number of orders we had received in last 3 months, how many orders do we expect in coming weeks.” Based on this query, the planner node may decide to invoke both the visualization tool and the prediction tool to give a more robust response. Based on what the visualization tool and the prediction tool respond back with, the response node may generate the relevant natural language output augmenting the chart-code obtained from the visualization tool. For instance, the response may include something like “based on these previous patterns [chart] we expect about 40 orders this week” (where a plot is inserted (e.g., as a picture, etc.) in place of “[chart]”).

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, video management, operations center oversight and control, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), small language models (SLMs), vision language models (VLMs), and/or multi-modal language models, systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

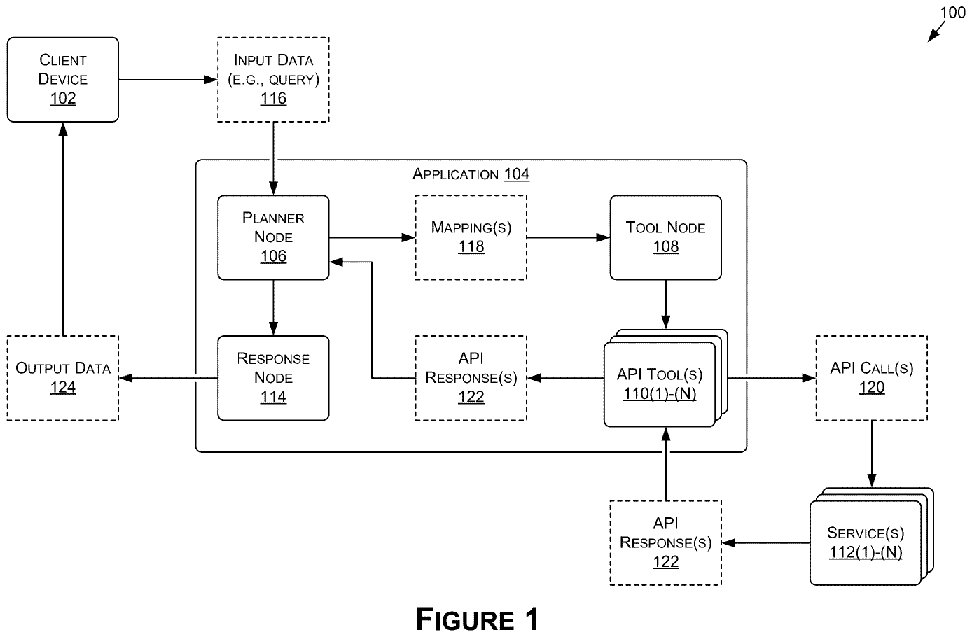

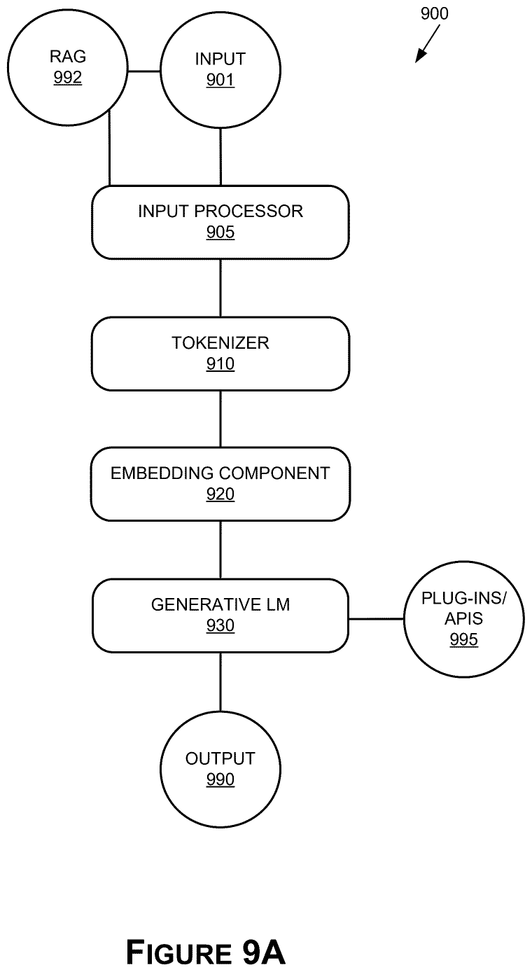

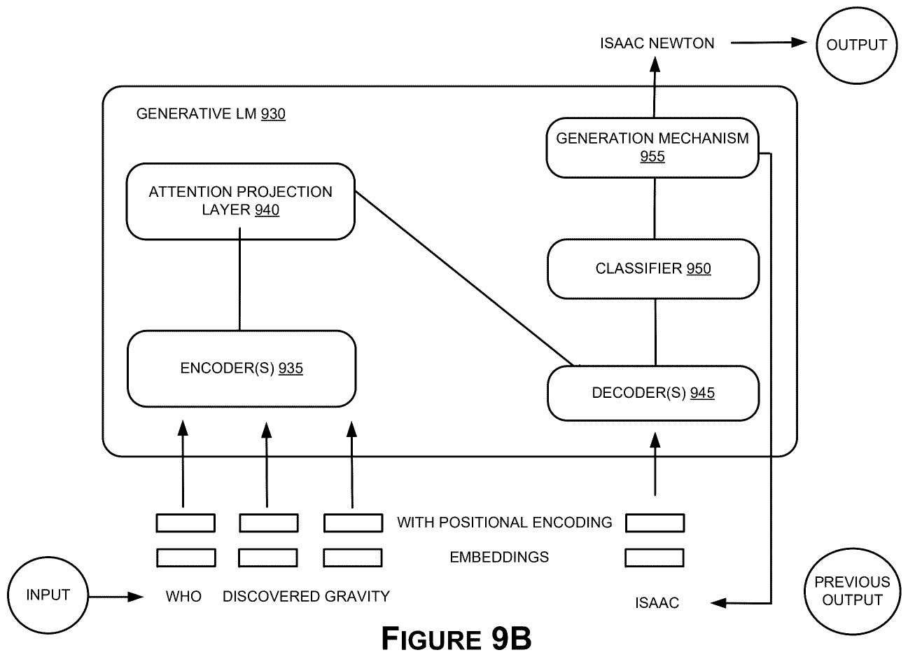

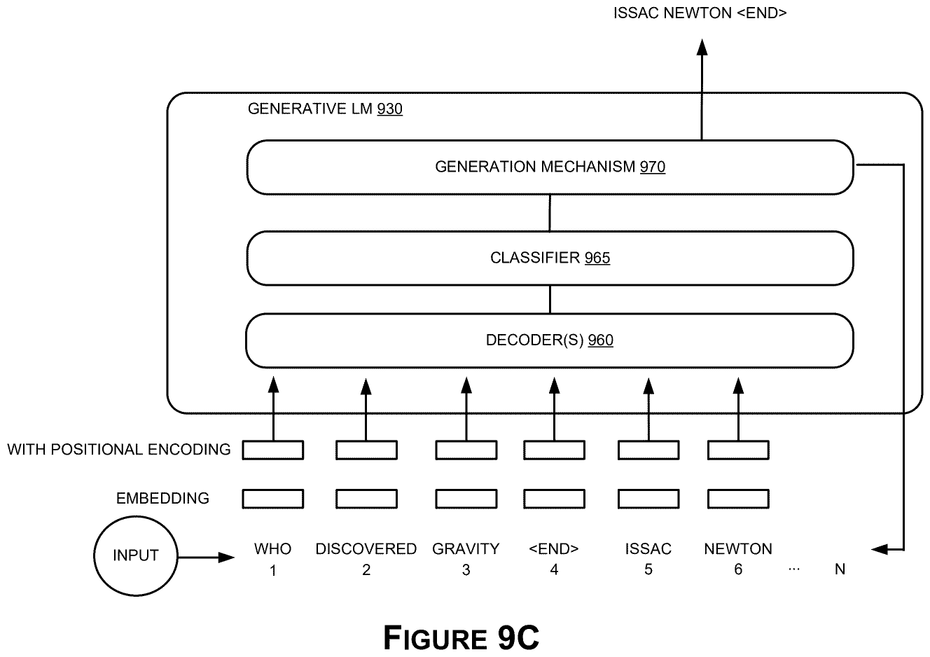

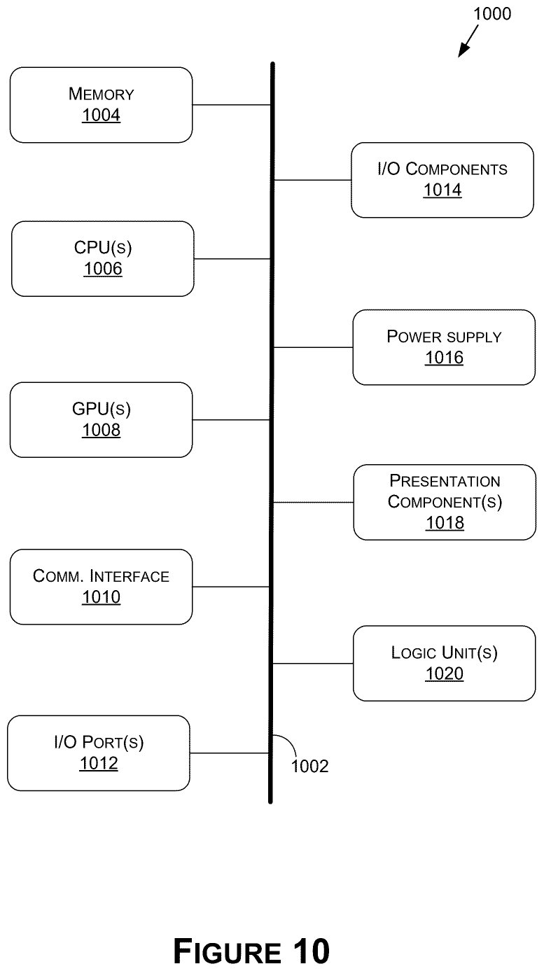

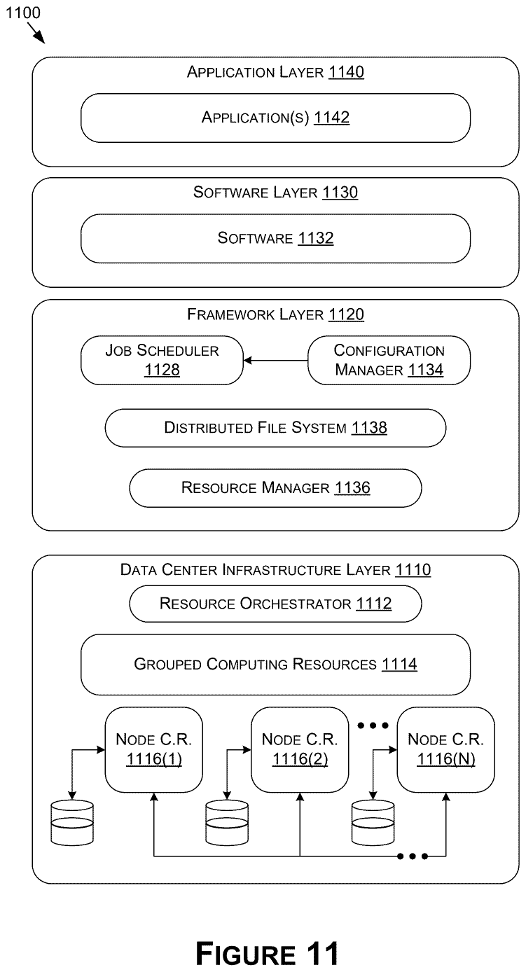

With reference to FIG. 1, FIG. 1 is a data flow diagram illustrating an example of a process 100 that may be performed by an application to provide a natural language interface for interacting with APIs of cloud-based services, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 9A-9C), one or more computing devices or components thereof (e.g., as described in FIG. 10), and/or one or more data centers or components thereof (e.g., as described in FIG. 11).

The process 100 may be implemented using, amongst additional or alterative components, a client device 102, an application 104, which may include a planner node 106, a tool node 108, one or more API tools 110(1)-110(N) (where “N” may represent any number), and a response node 114, as well as one or more services 112(1)-112(N). As a brief overview of the process 100, the application 104 may receive input data 116 from the client device 102, and the application 104 may use the planner node 106 to process the input data 116 and determine one or more mappings 118 of one or more queries in the input data 116 to one or more of the API tool(s) 110. The tool node 108 may use the mapping(s) 118 to map the query(ies) from the input data 116 to respective ones of the API tool(s) 110. The API tool(s) 110 may generate and make one or more API calls 120 to the service(s) 112, and the service(s) 112 may generate one or more API responses 122 and send the responses back to the API tool(s) 110. These API response(s) 122 may be sent back to the planner node 106 and the planner node 106 may use the responses to determine whether to call more tools or to use the response node 114 (also referred to herein as a “response generation node”) to generate output data 124 based at least on using a language model to convert the API response(s) 122 into natural language descriptions or other messages. The output data 124 may be sent to the client device 102, and the client device 102 may use the output data 124 to cause presentation of a response to the query included in the input data 116.

In some examples, the client device 102 may include any type of computing device, such as a desktop computer, laptop, server computer, smartphone, tablet, or any other computing device. The client device 102 may be executing an instance of a user interface, and the input data 116 may be received, via the user interface, as an input of a user of the client device 102. For instance, the user of the client device 102 may use the user interface to enter the query (e.g., by speaking or uttering the query, by typing the query, writing the query, using sign language to sign the query, etc.). As such, in some instance the input data 116 may include multimodal data representing the query. For instance, the input data 116 may include a combination of text data, audio data, video data, image data, and/or other data representing the query. As described herein, in various examples, the query may comprise a request for information (e.g., “what is the weather like today,” “how many people are in the building,” etc.), a request to control a machine or device or perform an action (e.g., “turn up the thermostat,” “lock the doors,” etc.), or any other request(s) or query(ies).

As shown, the application 104 (which may represent an agent (e.g., an “LLM agent”) or group of agents, in some examples) may include a plurality of nodes. In some instances, each one of the nodes (e.g., the planner node 106, the tool node 108, the response node 114, etc.) may be configured to perform a variety of different functions on behalf of the application 104 to generate a response to the query or queries included in the input data 116. For instance, each one of the nodes may be an AI-powered system designed to perform tasks autonomously by leveraging one or more language models and/or other machine learning models along with various integrated tools and/or resources. An example node may include a sophisticated language model that is capable of understanding and generating human-like text, enabling it to engage in conversations, answer questions, or generate content. The nodes/agents may also connect to external tools, such as the API tool(s) 110(1)-110(N) for data retrieval, web search functions, or databases, to extend their capabilities beyond simple text processing. These elements combined may allow the application 104 to perform a wide range of complex tasks efficiently and effectively.

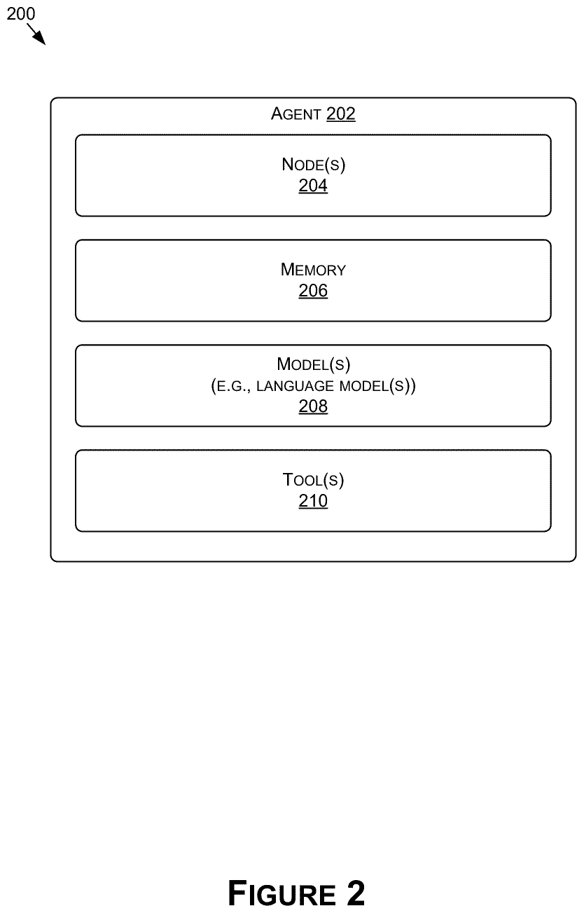

For instance, FIG. 2 is a block diagram illustrating example detail 200 associated with an agent 202, in accordance with some embodiments of the present disclosure. In various examples, the agent 202 may correspond to the application 104 from the example of FIG. 1. As shown in the example of FIG. 2, the agent 202 may include one or more nodes 204, which may correspond to any one of the planner node 106, the tool node 108, and/or the response node 114 from the example of FIG. 1, as well as memory 206, one or more models 208, and one or more tools 210. Although shown separately in the example of FIG. 2, the model(s) 208 may be ran inside of or executed using the node(s) 204.

In some instances, the memory 206 may serve as a repository for the internal records of the agent 202 and/or the agent's interactions with other agents, users, clients, APIs, services, etc. The memory 206 may include short-term memory and/or long-term memory. In some examples, the short-term memory may act as a ledger of the actions and thoughts the agent 202 processes while addressing a specific query or task, essentially capturing the agent's “train of thought.” In contrast, the long-term memory may function as a logbook that documents ongoing interactions and events between the agent 202 and other agents and/or users, encompassing conversation histories that can extend over weeks or months.

As described herein, the model(s) 208 may include one or more language models that serve as the core engine for understanding and generating human-like text. The model(s) 208 may process inputs by analyzing the context and intent behind queries, drawing on extensive training on diverse text data to produce coherent and contextually relevant responses. By leveraging advanced algorithms, such as those found in Transformer architectures, the model(s) 208 may capture nuanced meanings and relationships between words, allowing it to handle complex language tasks like conversation, summarization, and translation. Essentially, the model(s) 208 may enable the agent 202 to engage in meaningful interactions, adapt to different contexts, and provide informative answers, all while continuously learning from its interactions to enhance future performance. In some examples, the agent 202 may feed service specifications and/or API specifications into the model(s) 208 as inputs. For instance, the agent 202 may be configured to apply these specifications to the model(s) 208 contemporaneously with submitting requests or calls to the model(s) 208. In this way, instead of explicitly training the model(s) 208 to generate responses in a specific format, the agent 202 may “show” the model(s) 208 examples of the outputs it desires to receive. For instance, by feeding into the model(s) 208 an API specification contemporaneously with a query, the model(s) may use the API specification to determine how to correctly generate an API call responsive to the query.

While many of the examples described herein are with respect to using language models, and specifically, large language models, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural rendering field (NeRF) models, models with encoder-only architectures, models with decoder-only architectures, models with encoder-decoder architectures, generative machine learning models, language models, large language models (LLMs), small language models (LLMs), vision language models (VLMs), multi-modal language models (MMLMs), etc.), and/or other types of machine learning models.

The tool(s) 210 may represent or include defined, executable workflows that enable the agent 202 to perform various tasks efficiently. In some examples, these tool(s) 210 may include specialized third-party APIs designed to enhance the capabilities of the agent 202. For example, the tool(s) 210 of the agent 202 may include a Retrieval-Augmented Generation (RAG) pipeline to provide context-aware responses. Additionally, the agent 202 may use the tool(s) 210 to access external APIs to search for information online, retrieve real-time data from services such as weather APIs, or interact with instant messaging platforms. By leveraging its tool(s) 210, the agent 202 may expand its functionality, enabling the agent 202 to handle a wide range of inquiries and tasks with greater accuracy and relevance.

Referring back to the example of FIG. 1, the process 100 may include the planner node 106 receiving the input data 116 representing the query and determining the mapping(s) 118. In other words, the planner node 106 may determine which service(s) of the service(s) 112 (and/or which API tool(s) of the API tool(s) 110) to invoke to respond to the query. In some examples, the planner node 106 may use the language model(s) to analyze the input data 116 and determine the mapping(s) 118. Additionally, in some instances, the planner node 106 may use the language model(s) to decompose the input data 116 into a plurality of sub-queries (e.g., smaller, simpler queries than the entire query in the input data 116). For instance, if the input data 116 includes a query of “what's the weather like in California and what time does the ball game start,” the planner node 106 may use the language model(s) to break this query into at least a first query, “what's the weather like in California,” and a second query, “what time does the ball game start.” In such an example, the planner node 106 may also use the language model(s) to determine that different service(s) and/or API tool(s) should be invoke for the different queries (e.g., a weather service and a sports service).

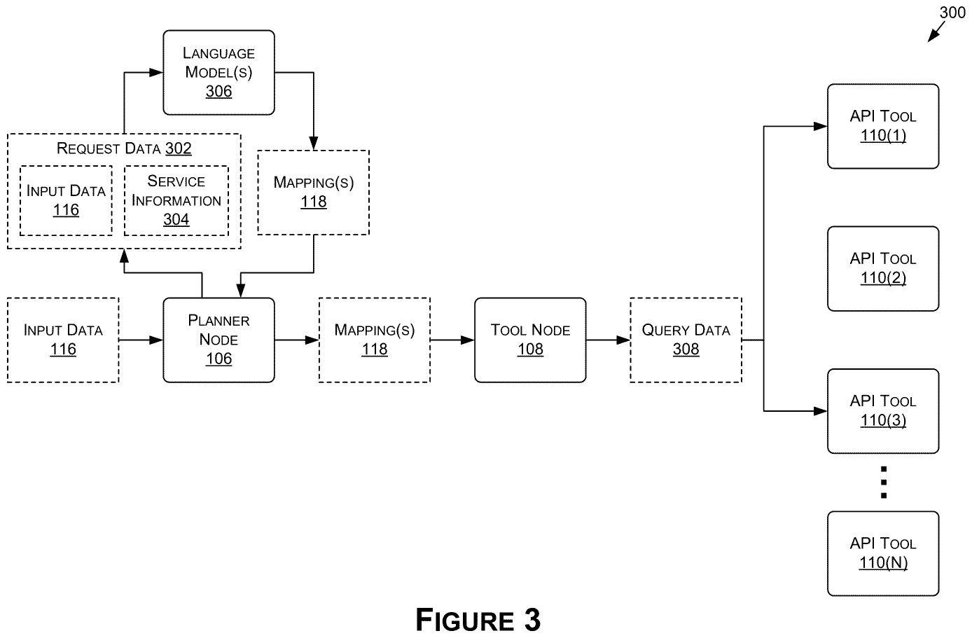

For instance, FIG. 3 is a data flow diagram illustrating an example of a process 300 that may be performed at least partially by the planner node 106 to select one or more optimal services for responding to a query, in accordance with some embodiments of the present disclosure. As shown, the process 300 may include the planner node 106 receiving the input data 116 and generating a request or call to one or more language model(s) 306. The request may include request data 302, and the request data 302 may include the input data 116 and service information 304 associated with services mapped to the API tools 110. In some examples, the service information 304 may include API specifications associated with the services and/or other information that indicates at least the capabilities or functionalities of the services. The language model(s) 306 may process the request data 302 and determine the mapping(s) 118, and the planner node 106 may forward the mapping(s) 118 to the tool node 108. The mapping(s) 118 may indicate which API tools 110 (and, ultimately, which services) to forward query data 308 to, where the query data may include one or more of the queries from the input data 116. For instance, in the example of FIG. 3, the mapping(s) 118 may indicate that the tool node 108 is to forward the query data 308 to the first API tool 110(1) and the third API tool 110(3), but not to the second API tool 110(2) and/or the Nth API tool 110(N).

Referring back to the example of FIG. 1, the process 100 may include the tool node 108 using the mapping(s) 118 to forward the queries to one or more of the API tool(s) 110. In some examples, each one of the API tool(s) 110 may correspond to or be associated with a specific service of the service(s) 112, thereby creating structured interaction pathways for executing the API call(s) 120. In some examples, the tool node 108 may be configured as a “dispatcher” node that may be responsible to call the API tool(s) 110 selected by the language model in the planner node 106. In some examples, the tool node 108 and/or the API tool(s) 110 may make multiple calls to the language model(s) to, among other things, perform query decomposition (if necessary), determine appropriate API endpoints to use for the API calls, and/or generate the API calls themselves (e.g., fill in parameters and/or other information).

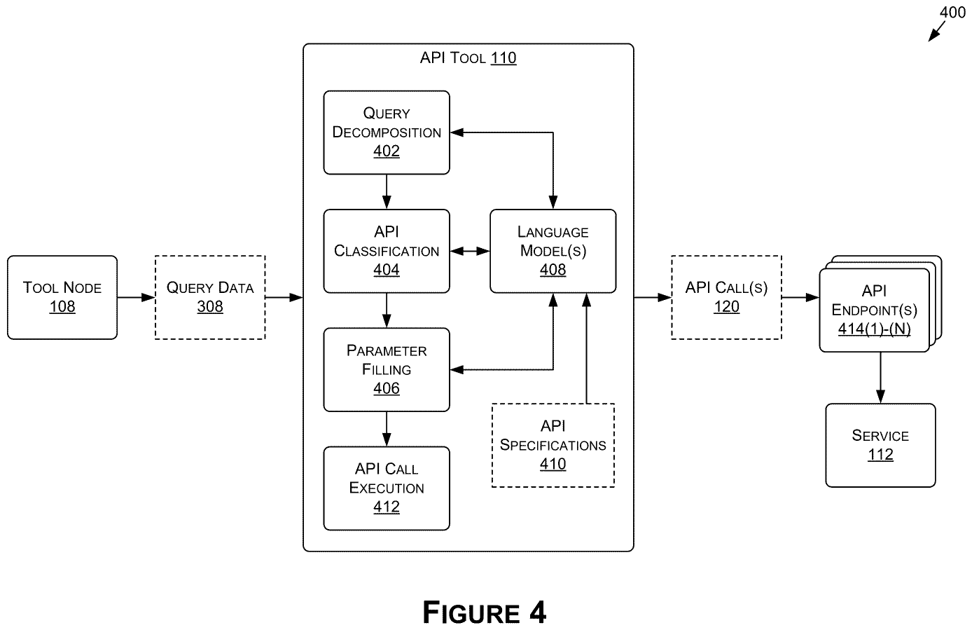

For instance, FIG. 4 is a data flow diagram illustrating an example of a process 400 performed at least partially by an API tool 110 of the tool node 108 to convert queries into API calls, in accordance with some embodiments of the present disclosure. The process 400 may include the tool node 108 forwarding the query data 308 to the API tool 110. In some examples, the tool node 108 may determine to forward the query data 308 to the API tool 110 based at least on the mapping(s) 118. In some examples, the query data 308 may include one or more portions of the input data 116 and/or one or more queries of the query included in the input data 116. For instance, the query data 308 may include text data representing a natural language query that the API tool 110 is capable of responding to by interacting with the service 112 it is mapped to.

Upon receiving, the query data 308, the API tool 110 may use a query decomposition component 402 to determine whether the query represented using the query data 308 needs to be decomposed into multiple queries. To do this, the query decomposition component 402 may call the language model(s) 408 (which may be the same as or different from the language model(s) 306) to process the query data 308. As an example, if a query were to ask “what is the weather in California and what is the weather in Idaho,” the query decomposition component 402 and/or the language model(s) 408 may decompose the query into two separate queries: a first query for “what is the weather in California” and a second query for “what is the weather in Idaho.” In this way, by decomposing the query, the API tool 110 may be able to generate separate API calls 120 for each of these queries and submit these API calls 120 separately to the backend service 112 it is mapped to.

In some examples, the API tool 110 may use an API classification node 404 to determine which APIs (e.g., which API endpoint(s) 414(1)-414(N)) of the service 112 to call. For instance, the API classification component 404 may call or use the language model(s) 408 to process the query data 308 (or decomposed query data) and API specifications 410 associated with the APIs of the service 112. By doing this, the API classification component 404 and/or the language model(s) 408 may determine which API endpoint(s) 414 to use to make the API call(s) 120 to the service 112. In some examples, the API classification component 404 and/or the language model(s) 408 may select the API endpoint(s) 414 based on the specific functionalities it provides and whether those functionalities match the operations that needs to be performed to respond to the query, such as retrieving data, updating resources, creating new entries, etc. This selection process may involve the language model(s) 408 consulting the API specifications 410 to understand the available API endpoint(s) 414, its HTTP methods (e.g., GET, POST, PUT, DELETE, etc.), required parameters, and response formats. For instance, the API specifications 410 associated with the service 112 may indicate one or more endpoints (e.g., URL addresses, etc.) corresponding to the APIs for the services, functionalities of the API endpoint(s) 414, parameters to be included in the payload of API call(s) 120, formats of the API requests or responses, or any other information associated with the APIs of the service 112.

In some examples, the API tool 110 may also use a parameter filling component 406 to generate the API call(s) 120 (e.g., the payload of the API requests). For instance, the parameter filling component 406 may apply, to the language model(s) 408, the query data 308 (or a portion thereof) and the API specifications 410 associated with the service 112. The language model(s) 408 may process these inputs and generate text data representing the API call(s) 120. That is, the language model(s) 408 may analyze the query data 308 and API specifications 410 to generate the payload for the API call(s) 120 by, at least, specifying the API endpoint(s) 414 to use, using an HTTP method (e.g., GET, POST, PUT, DELETE), and filling in the parameters and/or other data payloads for the API call(s) 120. In some examples, the API tool 110 may then use an API call execution component 412 to execute the API call(s) 120 by sending the request/message including the payload to the API endpoint(s) 414 of the service 112.

While this is just one example of how the tool node 108 and/or an API tool(s) 110 may generate an API call(s) 120 from a natural language query, in additional or alternative examples the tool node 108 and/or the API tool(s) 110 may use any other methods or processes to convert a natural language query into the API call(s) 120. For instance, instead of using multiple components to make multiple calls to the language model(s) 408, the API tool 110 may make a single call to the language model(s) 408 to generate ethe API call(s) 120, or may make more calls to the language model(s) 408 than described above with respect to the example of FIG. 4.

Referring back to the example of FIG. 1, the process 100 may include the API tool(s) 110 executing the API call(s) 120 to the service(s) 112, and receiving the API response(s) 122 back from the service(s) 112. The API tool(s) 110 may then forward the API response(s) 122 to the planner node 106. In any example, the planner node 106 may use the API response(s) 122 to determine whether to call additional tools or to invoke the response node 114 to generate a response to the query. For instance, the planner node 106 may use the language model to process the API response(s) 122 and/or any other information available to it to determine whether a response can be generated—in which case it may forward the responses or other information to the response node 114—or if additional tool calls need to be made in order to obtain any additional, necessary information for the response. In some instances, the API response(s) 122 to the API call(s) 120 may, in some instances, be in a format that is not a natural language format. For instance, the API response(s) 122 may include text data representing JSON format responses, XML format responses, or any other structured format response. However, as described herein, the response node 114 may use the language model(s) to convert the API response(s) 122 from the structured format into a natural language format/message.

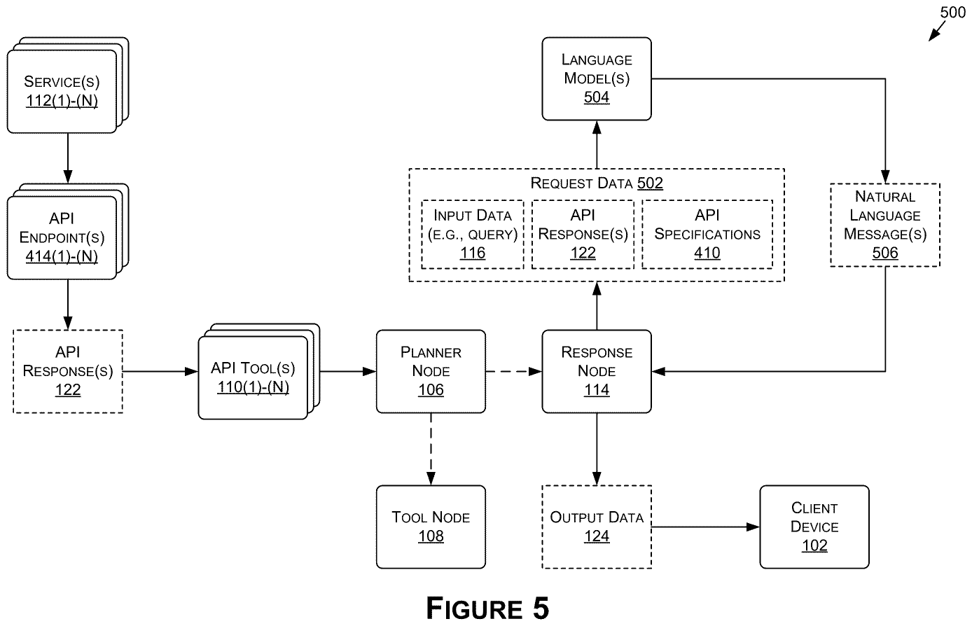

For instance, FIG. 5 is a data flow diagram illustrating an example of a process 500 performed at least partially by the response node 114 to convert a response to an API call into output data representing at least a natural language message, in accordance with some embodiments of the present disclosure. The process 500 includes the API tool(s) 110 receiving the API response(s) 122 from the API endpoint(s) 414 of the service(s) 112, and forward the API response(s) 122 to the planner node 106. Although not shown, the planner node 106 may use a language model to determine whether it has obtained all the necessary information to respond to the query, or if it needs to call additional tools or obtain any other information by invoking the tool node 108. In the example of FIG. 5, the planner node 106 determines it has all the necessary information to form the response to the query, and invokes the response node 114 to generate the response (e.g., instead of looping to continue trying to figure out how to respond to the query). The response node 114 may generate request data 502 and apply the request data 502 as input to one or more language model(s) 504, which may be the same as or different from the language model(s) 306 and/or 408. The request data 502 may include, in some examples, one or more of the input data 116, the API response(s) 122, and/or the API specifications 410. The language model(s) 504 may process the request data 502 and generate one or more natural language messages 506.

In some examples, the natural language message(s) 506 may include text representing a natural language message explaining the substance of the API response(s) 122. For instance, assume again that the query asked “what is the weather in California?” In such a scenario, the API response(s) 122 may include text representing a JSON format response (or other structured data format response), which may read something like the following:
“location”: {
   “city”: “Los Angeles”,
   “state”: “California”,
   “country”: “USA”},
“current_weather”: {
   “temperature”: “72° F.”,
   “humidity”: “60%”,
   “wind_speed”: “8 mph”,
   “condition”: “Sunny”},
“forecast”: [
   {“day”: “Monday”,
   “high”: “75° F.”,
   “low”: “58° F.”,
   “condition”: “Partly Cloudy”},
   {“day”: “Tuesday”,
   “high”: “78° F.”,
   “low”: “60° F.”,
   “condition”: “Sunny”},
   {“day”: “Wednesday”,
   “high”: “80° F.”,
   “low”: “62° F.”,
   “condition”: “Clear”}]}.

However, based at least on using the language model(s) 504 to process the request data 502 including the API specifications 410 (which may explain what the above keys, fields, and values mean), the natural language message(s) 506 may include a message that says something like: “The weather for Los Angeles is currently mild and sunny, with a high today of 72. You can expect similar conditions throughout the week with the daily highs reaching into the mid-70s to low-80s.” As another example, the natural language message(s) 506 may include a message that says something like: “The weather for Los Angeles, California is 72-degrees and sunny, with 60% humidity and 8 MPH winds.”

In some examples, the response node 114 may receive the natural language message(s) 506 back from the language model(s) 504, and include one or more portions of the natural language message(s) 506 in the output data 124. For instance, the response node 114 may generate the output data 124 using the natural language message(s) 506. In some examples, the output data 124 may include multimodal data. For instance, continuing the above example, in addition to including the natural language message(s) 506 describing the weather conditions, the output data 124 may include visual data (e.g., weather forecast graphics, video clips from the news forecast, etc.), audio data, and/or other data.

Referring back to the example of FIG. 1, the process 100 may include the application 104 sending the output data 124 to the client device 102. In some examples, the output data 124 may be presented by the client device 102 via an instance of a user interface executed on the client device 102. In other words, by sending the output data 124 to the client device, the application 104 may cause the client device 102 and/or the user interface to cause presentation of the response to the query. In some examples, causing presentation of the response may include, but is not limited to, outputting audio data of the response using one or more speakers of the client device 102, outputting visual data of the response (e.g., image data, video data, text data, analytics data, etc.) using a display of the client device 102, and/or outputting any other data using any other components or modalities of the client device 102.

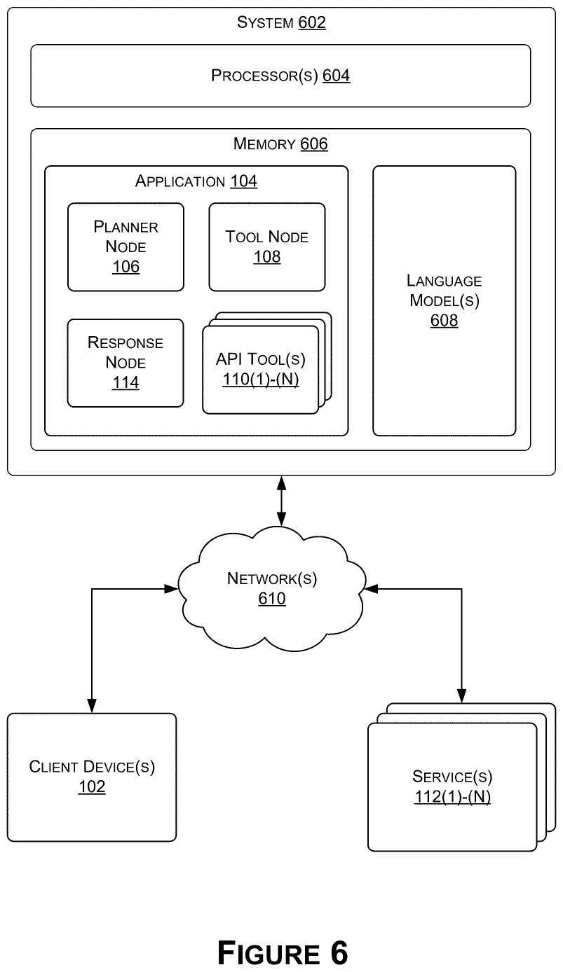

Referring now to FIG. 6, FIG. 6 is a block diagram illustrating an example of a system 602 that may perform one or more of the processes described herein, in accordance with some embodiments of the present disclosure. As shown, the system 602 (which may represent, and/or include, the example computing device(s) 1000 and/or the example data center 1100) may include one or more processors 604 (which may be similar to, and/or include, the CPUs 1006 and/or the GPUs 1008) and memory 606 (which may be similar to, and/or include, the memory 1004). For instance, the memory 606 may store one or more of the application 104, the planner node 106, the tool node 108, the API tool(s) 110, the response node 114, and/or one or more language models 608. Additionally, the processor(s) 604 may execute one or more of the application 104, the planner node 106, the tool node 108, the API tool(s) 110, the response node 114, and/or the language model(s) 608 to perform one or more of the processes described herein.

In some examples, the system 602 may communicate with the client device(s) 102 and/or the service(s) 112 over one or more network(s) 610. For instance, the system 602 may receive input data representing a natural language query from the client device(s) 102, and use the processor(s) 604 to execute the application 104 (and/or its components) and/or use the language model(s) 608 to convert the natural language query into one or more API calls to send to the service(s) 112. The system 602 may also receive responses to the API calls from the service(s) 112, and convert the responses into natural language messages to send back to the client device(s) 102.

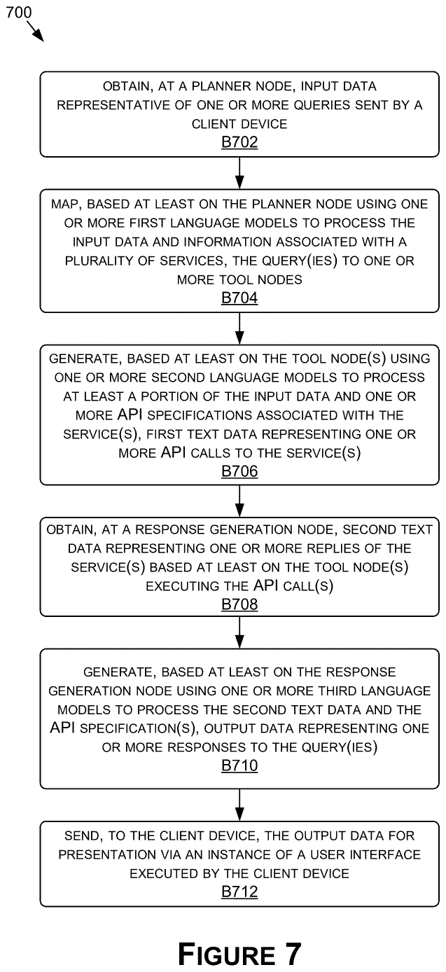

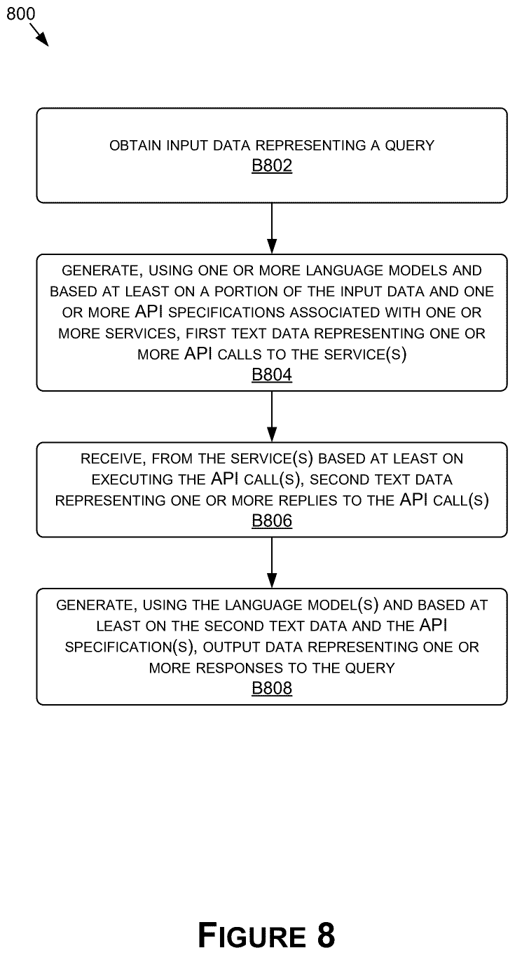

Now referring to FIGS. 7 and 8, each block of methods 700 and 800, described herein, comprises a computing process that may be performed using any combination of hardware, firmware, and/or software. For instance, various functions may be carried out using one or more processors executing instructions stored in one or more memories. The methods may also be embodied as computer-usable instructions stored on computer storage media. The methods may be provided by a standalone application, a service or hosted service (standalone or in combination with another hosted service), as a microservice via an application programming interface (API) or a plug-in to another product, to name a few. In addition, methods 700 and 800 are described, by way of example, with respect to the system of FIG. 1. However, these methods may additionally or alternatively be executed by any one system, or any combination of systems, including, but not limited to, those described herein.

FIG. 7 is a flow diagram illustrating an example of a method 700 that may be performed to provide a natural language interface for interacting with APIs of a service, in accordance with some embodiments of the present disclosure. The method 700, at block B702, includes obtaining, at a planner node, input data representative of one or more queries sent by a client device. For instance, the planner node 106 may obtain the input data 116 representative of the query(ies) sent by the client device 102.

The method 700, at block B704, includes mapping, based at least on the planner node using one or more first language models to process the input data and information associated with a plurality of services, the query(ies) to one or more tool nodes. For instance, the planner node 106 may use the first language model(s) to process the input data 116 and the information associated with the service(s) 112, and map the query(ies) to the API tool(s) 110. For instance, if the input data includes a first query asking for information about weather and a second query asking for information about a sports team, then the first query may be mapped or routed to a first API tool corresponding to a weather-related service or application and the second query may be mapped or routed to a second API tool corresponding to a sports-related service or application.

The method 700, at block B706, includes generating, based at least on the tool node(s) using one or more second language models to process at least a portion of the input data and one or more API specifications associated with the service(s), first text data representing one or more API calls to the service(s). For instance, the API tool(s) 110 (and/or the tool node 108) may generate the first text data representing the API call(s) 120 to the service(s) 112 based at least on using the second language model(s) to process the portion of the input data 116 and the API specifications associated with the service(s) 112. In some examples, the second language model(s) may be the same as or different from the first language model(s). Additionally, in some instances, the API tool(s) 110 may execute a plurality of calls to the second language model(s) to generate the API call(s) 120. For instance, the API tool(s) 110 may make a first call to the second language model(s) to decompose or simplify the query, make a second call to the second language model(s) to classify the API endpoint(s) for the service(s) 112, and make a third call to the second language model(s) to fill in the parameters or payload of the API call(s) 120 and/or requests.

The method 700, at block B708, includes obtaining, at a response generation node, second text data representing one or more replies of the service(s) based at least on the tool node(s) executing the API call(s). For instance, the response node 114 may obtain the second text data representing the API response(s) 122 based at least on the API tool(s) 110 executing the API call(s) 120. In some examples, the second text data may be in a structured data format, such as a JSON format, an XML format, or any other structured data format.

The method 700, at block B710, includes generating, based at least on the response generation node using one or more third language models to process the second text data and the API specification(s), output data representing one or more responses to the query(ies). For instance, the response node 114 may generate the output data 124 based at least on using the third language model(s) to process at least the second text data (e.g., the API response(s) 122) and the API specification(s). In some examples, the third language model(s) may be the same as or different from one or more of the first language model(s) and/or the second language model(s). In some examples, the response node 114 may use the third language model(s) to convert the API response(s) 122 into natural language messages, and one or more portions of the natural language messages may be included in the output data 124.

The method 700, at block B712, includes sending, to the client device, the output data for presentation via an instance of a user interface executed by the client device. For instance, the response node 114 and/or the application 104 may send the output data 124 to the client device 102. In some examples, the client device 102 may be executing an instance of a user interface, and the user interface may use the output data 124 to cause presentation of the response to the original query (e.g., by display the natural language message on a screen, by outputting audio data representing an utterance of the natural language message, etc.).

FIG. 8 is a flow diagram illustrating an example of a method 800 for converting natural language queries into API calls and translating responses to the API calls back into natural language replies to the queries, in accordance with some embodiments of the present disclosure. The method 800, at block B802, includes obtaining input data representing a query. For instance, the planner node 106 of the application 104 may obtain the input data 116 representing the query.

The method 800, at block B804, includes generating, using one or more language models and based at least on a portion of the input data and one or more API specifications associated with one or more services, first text data representing one or more API calls to the service(s). For instance, the tool node 108 of the application 104 may use the API tool(s) 110, which may execute one or more calls to the language model(s), to generate the first text data representing the API call(s) 120.

The method 800, at block B806, includes receiving, from the service(s) based at least on executing the API call(s), second text data representing one or more replies to the API call(s). For instance, the response node 114 may receive the second text data representing the replies to the API call(s) 120.

The method 800, at block B808, includes generating, using the language model(s) and based at least the second text data and the API specification(s), output data representing one or more responses to the query. For instance, the response node 114 may generate the output data 124 representing the response(s) to the query based at least on using the language model(s) to process the second text data and the API specification(s).

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 9A is a block diagram of an example generative language model system 900 suitable for use in implementing at least some embodiments of the present disclosure. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a SLM, a VLM, a multi-modal LM, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 930 (e.g., LLM/SLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/SLM/VLM/MMLM/etc. with external knowledge, so that answers to specific questions or queries or requests are more relevant—such as in a case where specific knowledge is required. The RAG component 992 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history—or at least a summary thereof—and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST (Representational State Transfer) interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features—such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use—or capable of accessing or using—plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated—e.g., recursively—for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources—such as the plug-ins/APIs 995.

FIG. 9B is a block diagram of an example implementation in which the generative LM 930 includes a transformer encoder-decoder. For example, assume input text such as “Who discovered gravity” is tokenized (e.g., by the tokenizer910 of FIG. 9A) into tokens such as words, and each token is encoded (e.g., by the embedding component 920 of FIG. 99A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 940 may convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 may generate a first token, and the generation mechanism 955 may apply the generated token as an input during a second pass. The process may repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 may output some decoded (e.g., vector) representation of the input being applied during a particular pass. The classifier 950 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 955 may select or sample a word or token based on a corresponding predicted probability (e.g., select the word with the highest predicted probability) and append it to the output from a previous pass, generating each word or token sequentially. The generation mechanism 955 may repeat the process, triggering successive decoder inputs and corresponding predictions until selecting or sampling a symbol or token that represents the end of the response, at which point, the generation mechanism 955 may output the generated response.

FIG. 9C is a block diagram of an example implementation in which the generative LM 930 includes a decoder-only transformer architecture. For example, the decoder(s) 960 of FIG. 9C may operate similarly as the decoder(s) 945 of FIG. 9B except each of the decoder(s) 960 of FIG. 9C omits the encoder-decoder self-attention layer (since there is no encoder in this implementation). As such, the decoder(s) 960 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 960. As with the decoder(s) 945 of FIG. 9B, each token (e.g., word) may flow through a separate path in the decoder(s) 960, and the decoder(s) 960, a classifier 965, and a generation mechanism 970 may use auto-regression to sequentially generate one token at a time until predicting a symbol or token that represents the end of the response. The classifier 965 and the generation mechanism 970 may operate similarly as the classifier 950 and the generation mechanism 955 of FIG. 9B, with the generation mechanism 970 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may use distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: obtaining, at a planner node associated with an application that provides a natural language interface for a client device to communicate with a plurality of services, input data representative of one or more queries sent by the client device; mapping, based at least on the planner node using one or more first language models to process the input data and information associated with the plurality of services, the one or more queries to one or more tool nodes associated with the application, wherein an individual tool node of the one or more tool nodes is mapped to one or more services of the plurality of services; generating, based at least on the one or more tool nodes using one or more second language models to process at least a portion of the input data and one or more application programming interface (API) specifications associated with the one or more services, first text data representing one or more API calls to the one or more services; obtaining, at a response generation node associated with the application, second text data representing one or more replies of the one or more services based at least on the one or more tool nodes executing the one or more API calls; generating, based at least on the response generation node using one or more third language models to process at least the second text data and the one or more API specifications, output data representing one or more responses to the one or more queries; and sending, to the client device, the output data for presentation using the client device.

B. The method of paragraph A, further comprising: determining, based at least on the one or more tool nodes using the one or more second language models to process at least the portion of the input data and the one or more API specifications, at least: one or more API endpoints associated with the one or more services; and one or more parameters to include in the one or more API calls, wherein the generating of the first text data representing the one or more API calls is based at least on the determining of the one or more API endpoints and the determining of the one or more parameters.

C. The method of any one of paragraphs A-B, further comprising: decomposing, based at least on the planner node using the one or more first language models to process the input data, the one or more queries into at least a first query and a second query, wherein the mapping of the one or more queries to the one or more tool nodes comprises mapping the first query to a first tool node and mapping the second query to a second tool node.

D. The method of any one of paragraphs A-C, further comprising: decomposing, based at least on the one or more tool nodes using the one or more second language models to process the input data, the input data into at least a first portion of the input data corresponding to a first query of the one or more queries and a second portion of the input data corresponding to a second query of the one or more queries, wherein the generating of the first text data representing the one or more API calls comprises: generating a first portion of the first text data representing a first API call corresponding to the first query; and generating a second portion of the first text data representing a second API call corresponding to the second query.

E. The method of any one of paragraphs A-D, wherein the one or more responses include one or more multimodal responses and the output data includes a combination of two or more of text data, image data, video data, or audio data.

F. The method of any one of paragraphs A-E, wherein the information associated with the plurality of services is indicative of at least one of one or more tools, one or more capabilities, or one or more functionalities of an individual service of the plurality of services.

G. The method of any one of paragraphs A-F, wherein the one or more API specifications associated with the one or more services indicate at least: one or more endpoints corresponding to one or more APIs for the one or more services; one or more functionalities of the one or more endpoints; one or more parameters to be included in one or more requests sent to the one or more endpoints; and one or more formats of the one or more requests.

H. The method of any one of paragraphs A-G, wherein the generating of the output data is further based at least on the response generation node using the one or more third language models to process at least the input data, the second text data, and response format information from the one or more API specifications.

I. A system comprising: one or more processors to: obtain, from a computing device, input data representing a query; generate, using one or more language models and based at least on at least a portion of the input data and one or more application programming interface (API) specifications associated with one or more services of a plurality of services, first text data representing one or more API calls to the one or more services; receive, from the one or more services and based at least on executing the one or more API calls, second text data representing one or more replies to the one or more API calls; generate, using the one or more language models and based at least on the second text data and the one or more API specifications, output data representing one or more responses to the query; and send the output data to the computing device.

J. The system of paragraph I, the one or more processors further to: map, using the one or more language models and based at least on the input data and information associated with the plurality of services, the query to the one or more services; obtain, based at least on the mapping, the one or more API specifications associated with the one or more services; and apply the one or more API specifications and the portion of the input data to the one or more language models.

K. The system of any one of paragraphs I-J, the one or more processors further to: determine, using the one or more language models and based at least on the portion of the input data and the one or more API specifications, at least: one or more API endpoints associated with the one or more services; and one or more parameters to include in the one or more API calls, wherein the generation of the first text data is based at least on the determination of the one or more API endpoints and the one or more parameters.

L. The system of any one of paragraphs I-K, the one or more processors further to: decompose, using the one or more language models, the query into at least a first query and one or more second queries, wherein the generation of the first text data comprises: generating, using the one or more language models and based at least on the one or more API specifications and a first portion of the input data corresponding to the first query, one or more first portions of the first text data representing one or more first API calls to the one or more services; and generating, using the one or more language models and based at least on the one or more API specifications and one or more second portions of the input data corresponding to the one or more second queries, one or more second portions of the first text data representing one or more second API calls to the one or more services.

M. The system of any one of paragraphs I-L, the one or more processors further to: determine, using the one or more language models and based at least on the input data and the one or more API specifications, an order in which to make a sequence of API calls to a series of services of the plurality of services; and execute the sequence of API calls by sending one or more portions of the first text data to the series of services based at least on the order.

N. The system of any one of paragraphs I-M, the one or more processors further to: send, to the one or more language models, a first request for the one or more language models to identify the one or more services of the plurality of services to invoke to generate the one or more responses to the query; send, to the one or more language models, a second request for the one or more language models to generate the first text data representing the one or more API calls, the one or more API calls including, based at least on the one or more API specifications, at least: one or more endpoint identifiers corresponding to one or more APIs for the one or more services; and one or more parameters indicative of one or more operations to be performed by at least one of the one or more APIs or the one or more services, wherein the generation of the first text data using the one or more language models is based at least on the sending of the first request and the second request.

O. The system of any one of paragraphs I-N, wherein based at least on executing the one or more API calls, the one or more services are to: transform, using one or more second language models and based at least on the query, the first text data into a plurality of values; and generate, using one or more machine learning models and based at least on the plurality of values, at least one of a visual representation associated with the plurality of values or one or more predicted values.

P. The system of any one of paragraphs I-O, the one or more processors further to: determine, using the one or more language models and based at least on the input data and information associated with the plurality of services, a ranking for each service of the plurality of services; select the one or more services from the plurality of services based at least on one or more first rankings of the one or more services being greater than one or more second rankings of one or more second services of the plurality of services; and send, to one or more API endpoints associated with the one or more services, the first text data representing the one or more API calls.

Q. The system of any one of paragraphs I-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using a small language model; a system for performing operations using one or more vision language models (VLMs); a system for performing operations using one or more multi-modal language models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

R. One or more processors comprising: processing circuitry to: route one or more natural language queries to one or more tools mapped to one or more services of a plurality of services based at least on using one or more language models to process at least the one or more natural language queries and data indicating one or more specifications associated with the one or more services; and generate one or more application programming interface (API) calls to the one or more services based at least on using the one or more language models to process at least the one or more natural language queries and one or more API specifications associated with the one or more services.

S. The one or more processors of paragraph R, wherein the one or more services comprise one or more Representational State Transfer (REST) API services.

T. The one or more processors as recited in any one of paragraphs R-S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using a small language model; a system for performing operations using one or more vision language models (VLMs); a system for performing operations using one or more multi-modal language models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
obtaining, at a planner node associated with an application that provides a natural language interface for a client device to communicate with a plurality of services, input data representative of one or more queries sent by the client device;
mapping, based at least on the planner node using one or more first language models to process the input data and information associated with the plurality of services, the one or more queries to one or more tool nodes associated with the application, wherein an individual tool node of the one or more tool nodes is mapped to one or more services of the plurality of services;
generating, based at least on the one or more tool nodes using one or more second language models to process at least a portion of the input data and one or more application programming interface (API) specifications associated with the one or more services, first text data representing one or more API calls to the one or more services;
obtaining, at a response generation node associated with the application, second text data representing one or more replies of the one or more services based at least on the one or more tool nodes executing the one or more API calls;
generating, based at least on the response generation node using one or more third language models to process at least the second text data and the one or more API specifications, output data representing one or more responses to the one or more queries; and
sending, to the client device, the output data for presentation using the client device.

2. The method of claim 1, further comprising:
determining, based at least on the one or more tool nodes using the one or more second language models to process at least the portion of the input data and the one or more API specifications, at least:
one or more API endpoints associated with the one or more services; and
one or more parameters to include in the one or more API calls,
wherein the generating of the first text data representing the one or more API calls is based at least on the determining of the one or more API endpoints and the determining of the one or more parameters.

3. The method of claim 1, further comprising:
decomposing, based at least on the planner node using the one or more first language models to process the input data, the one or more queries into at least a first query and a second query,
wherein the mapping of the one or more queries to the one or more tool nodes comprises mapping the first query to a first tool node and mapping the second query to a second tool node.

4. The method of claim 1, further comprising:
decomposing, based at least on the one or more tool nodes using the one or more second language models to process the input data, the input data into at least a first portion of the input data corresponding to a first query of the one or more queries and a second portion of the input data corresponding to a second query of the one or more queries,
wherein the generating of the first text data representing the one or more API calls comprises:
generating a first portion of the first text data representing a first API call corresponding to the first query; and
generating a second portion of the first text data representing a second API call corresponding to the second query.

5. The method of claim 1, wherein the one or more responses include one or more multimodal responses and the output data includes a combination of two or more of text data, image data, video data, or audio data.

6. The method of claim 1, wherein the information associated with the plurality of services is indicative of at least one of one or more tools, one or more capabilities, or one or more functionalities of an individual service of the plurality of services.

7. The method of claim 1, wherein the one or more API specifications associated with the one or more services indicate at least:
one or more endpoints corresponding to one or more APIs for the one or more services;
one or more functionalities of the one or more endpoints;
one or more parameters to be included in one or more requests sent to the one or more endpoints; and
one or more formats of the one or more requests.

8. The method of claim 1, wherein the generating of the output data is further based at least on the response generation node using the one or more third language models to process at least the input data, the second text data, and response format information from the one or more API specifications.

9. A system comprising:
one or more processors to:
obtain, from a computing device, input data representing a query;
generate, using one or more language models and based at least on at least a portion of the input data and one or more application programming interface (API) specifications associated with one or more services of a plurality of services, first text data representing one or more API calls to the one or more services;
receive, from the one or more services and based at least on executing the one or more API calls, second text data representing one or more replies to the one or more API calls;
generate, using the one or more language models and based at least on the second text data and the one or more API specifications, output data representing one or more responses to the query; and
send the output data to the computing device.

10. The system of claim 9, the one or more processors further to:
map, using the one or more language models and based at least on the input data and information associated with the plurality of services, the query to the one or more services;
obtain, based at least on the mapping, the one or more API specifications associated with the one or more services; and
apply the one or more API specifications and the portion of the input data to the one or more language models.

11. The system of claim 9, the one or more processors further to:
determine, using the one or more language models and based at least on the portion of the input data and the one or more API specifications, at least:
one or more API endpoints associated with the one or more services; and
one or more parameters to include in the one or more API calls,
wherein the generation of the first text data is based at least on the determination of the one or more API endpoints and the one or more parameters.

12. The system of claim 9, the one or more processors further to:
decompose, using the one or more language models, the query into at least a first query and one or more second queries,
wherein the generation of the first text data comprises:
generating, using the one or more language models and based at least on the one or more API specifications and a first portion of the input data corresponding to the first query, one or more first portions of the first text data representing one or more first API calls to the one or more services; and
generating, using the one or more language models and based at least on the one or more API specifications and one or more second portions of the input data corresponding to the one or more second queries, one or more second portions of the first text data representing one or more second API calls to the one or more services.

13. The system of claim 9, the one or more processors further to:
determine, using the one or more language models and based at least on the input data and the one or more API specifications, an order in which to make a sequence of API calls to a series of services of the plurality of services; and
execute the sequence of API calls by sending one or more portions of the first text data to the series of services based at least on the order.

14. The system of claim 9, the one or more processors further to:
send, to the one or more language models, a first request for the one or more language models to identify the one or more services of the plurality of services to invoke to generate the one or more responses to the query;
send, to the one or more language models, a second request for the one or more language models to generate the first text data representing the one or more API calls, the one or more API calls including, based at least on the one or more API specifications, at least:
one or more endpoint identifiers corresponding to one or more APIs for the one or more services; and
one or more parameters indicative of one or more operations to be performed by at least one of the one or more APIs or the one or more services,
wherein the generation of the first text data using the one or more language models is based at least on the sending of the first request and the second request.

15. The system of claim 9, wherein based at least on executing the one or more API calls, the one or more services are to:
transform, using one or more second language models and based at least on the query, the first text data into a plurality of values; and
generate, using one or more machine learning models and based at least on the plurality of values, at least one of a visual representation associated with the plurality of values or one or more predicted values.

16. The system of claim 9, the one or more processors further to:
determine, using the one or more language models and based at least on the input data and information associated with the plurality of services, a ranking for each service of the plurality of services;
select the one or more services from the plurality of services based at least on one or more first rankings of the one or more services being greater than one or more second rankings of one or more second services of the plurality of services; and
send, to one or more API endpoints associated with the one or more services, the first text data representing the one or more API calls.

17. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using a small language model;
a system for performing operations using one or more vision language models (VLMs);
a system for performing operations using one or more multi-modal language models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. One or more processors comprising:
processing circuitry to:
route one or more natural language queries to one or more tools mapped to one or more services of a plurality of services based at least on using one or more language models to process at least the one or more natural language queries and data indicating one or more specifications associated with the one or more services; and
generate one or more application programming interface (API) calls to the one or more services based at least on using the one or more language models to process at least the one or more natural language queries and one or more API specifications associated with the one or more services.

19. The one or more processors of claim 18, wherein the one or more services comprise one or more Representational State Transfer (REST) API services.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using a small language model;
a system for performing operations using one or more vision language models (VLMs);
a system for performing operations using one or more multi-modal language models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
